(19) United States
(12) Patent Application Publication
(10) Pub. No.: US 2025/0103911 A1
(43) Pub. Date: Mar. 27, 2025

(54) USER ELECTRICITY CONSUMPTION PATTERN CLASSIFICATION SYSTEM AND METHOD

(71) Applicant: INSTITUTE FOR INFORMATION INDUSTRY, TAIPEI CITY (TW)

(72) Inventors: Su-An LIU, TAIPEI CITY (TW); Kuei-Chun CHIANG, TAIPEI CITY (TW); Yung-Chieh HUNG, TAIPEI CITY (TW)

(73) Assignee: INSTITUTE FOR INFORMATION INDUSTRY, TAIPEI CITY (TW)

(21) Appl. No.: 18/384,129

(22) Filed: Oct. 26, 2023

(30) Foreign Application Priority Data
Sep. 22, 2023 (TW) 112136359

(51) Int. Cl. G06N 5/022

(52) U.S. Cl. CPC G06N 5/022

(57) ABSTRACT

An electricity consumption pattern classification method involves, initially, reading multiple training electricity consumption data sets. After which, the method includes performing a first clustering phase with a first machine learning clustering algorithm according to the electricity consumption characteristics of the training electricity consumption data sets, and generating multiple first-level data groups. Then, second-level feature values of the training electricity consumption data sets are generated with a feature extraction algorithm, and a second clustering phase with a second machine learning clustering algorithm is performed to generate second-level data groups under the first-level data groups. The classification result of an unclassified data set is determined according to the average similarity between the unclassified data set and each second-level data group. The second-level data groups produced by the two-phase clustering accurately represent the different electricity consumption patterns in the data sets, thereby providing precise electricity consumption pattern classification results.

### CROSS-REFERENCE TO RELATED APPLICATIONS

This application claims the priority benefit of TW application serial No. 112136359, filed on Sep. 22, 2023. The entirety of the above-mentioned patent application is hereby incorporated by reference herein and made a part of the specification.

### BACKGROUND OF THE INVENTION

### 1. Field of the Inventions

The present invention relates to a classification system and method, and more particularly to a user electricity consumption pattern classification system and method.

### 2. Description of the Related Art

The increasing demand for energy has highlighted the importance of both developing energy technologies to augment energy supply and implementing measures to conserve energy and reduce consumption. To enhance energy utilization efficiency, in recent years, an international trend in energy conservation has been to employ cloud platforms and behavioral science combined with big data analytics in electricity, analyzing the electricity consumption behaviors of household users or other individual consumers. Furthermore, based on the analytized results, personalized improvement suggestions are provided, motivating the users or entities to adjust their electricity consumption habits to meet energy-saving goals.

Existing electricity consumption analysis techniques generally involve plotting an electricity load curve for an entity over a given time period (e.g., one day), with multiple time units (e.g., every half-hour). The shape and composition of the electricity load curve are then used to analyze electricity consumption behaviors during different time slots, thereby generating analytical outcomes. For instance, if an entity's electricity consumption is low in the morning and afternoon but high in the evening, recommendations for modifications or adjustments are made based on the pattern.

However, current electricity consumption analysis techniques are limited by the inputted analytical factors. The obtained results only allow for a broad comparison of electricity consumption proportions of different time slots, and therefore yielding limited adjustment suggestions. Additionally, how to integrate the analytical results of large amount of entities, and harness big data for a comprehensive analysis to provide improvement plans for the energy industry, remains an urgent issue awaiting resolution in the field of energy technology development.

### SUMMARY OF THE INVENTION

An objective of the present invention is to provide a user electricity consumption pattern classification system and method.

To achieve the foregoing objective, the user electricity consumption pattern classification system includes:
a storage device, storing multiple training electricity consumption data sets, each of the training electricity consumption data sets including multiple unit-time electricity consumption values with temporal dependence, and each of the training electricity consumption data sets having a consumption amount feature information; and
a processing device, connected to the storage device, configured to read the training electricity consumption data sets from the storage device;
the processing device utilizing the consumption amount feature information of the training electricity consumption data sets as a first-level feature value and, based on a first clustering quantity value, classifying the training electricity consumption data sets into multiple first-level electricity consumption data groups through a first machine learning clustering algorithm;
the processing device calculating, through a feature extraction algorithm, at least one second-level feature value for each training electricity consumption data set;
within each of the first-level electricity consumption data groups, the processing device, based on the at least one second-level feature value of each of the training electricity consumption data sets, and based on a second clustering quantity value of each of the first-level electricity consumption data groups, classifying the training electricity consumption data sets into multiple second-level electricity consumption data groups through a second machine learning clustering algorithm, and assigning an electricity consumption pattern label to each of the second-level electricity consumption data groups; and
the processing device receiving an unclassified electricity consumption data set, calculating an average similarity between the unclassified electricity consumption data set and the training electricity consumption data sets within each of the second-level electricity consumption data groups, selecting the electricity consumption pattern label of the second-level electricity consumption data group with the highest average similarity as the classification result for the unclassified electricity consumption data set, and outputting the electricity consumption pattern classification result.

Additionally, the user electricity consumption pattern classification method of the present invention is executed by a processing device, including the following steps:
reading multiple training electricity consumption data sets, each of the training electricity consumption data set including multiple unit-time electricity consumption values with temporal dependence, and each of the training electricity consumption data sets having a consumption amount feature information;
utilizing the consumption amount feature information of the training electricity consumption data sets as a first-level feature value and, based on a first clustering quantity value, classifying the training electricity consumption data sets into multiple first-level electricity consumption data groups through a first machine learning clustering algorithm;
calculating, through a feature extraction algorithm, at least one second-level feature value for each training electricity consumption data set;
within each of the first-level electricity consumption data groups, based on the at least one second-level feature value of each of the training electricity consumption data sets, and based on a second clustering quantity value of each of the first-level electricity consumption data groups, classifying the training electricity consumption data sets into multiple second-level electricity consumption data groups through a second machine learning clustering algorithm, and assigning an electricity consumption pattern label to each of the second-level electricity consumption data groups;
receiving an unclassified electricity consumption data set, calculating an average similarity between the unclassified electricity consumption data set and the training electricity consumption data sets within each of the second-level electricity consumption data groups, selecting the electricity consumption pattern label of the second-level electricity consumption data group with the highest average similarity as the classification result for the unclassified electricity consumption data set, and outputting the electricity consumption pattern classification result.

The user electricity consumption pattern classification system and method of the present invention primarily utilize the electricity consumption feature information of each training electricity consumption data set as a first-level feature value to carry out the first clustering algorithm, generating a specified number of first-level electricity consumption data groups. Subsequently, through a feature extraction algorithm, the second-level feature values of the training electricity consumption data sets are obtained. Based on these second-level feature values, a second clustering algorithm is performed on the training electricity consumption data sets under each first-level electricity consumption data group, generating second-level electricity consumption data groups and assigning them electricity consumption pattern labels.

These second-level electricity consumption data groups are the final result of clustering. Each second-level electricity consumption data group represents a classification type that reflects a user electricity consumption pattern. When the processing device receives an unclassified electricity consumption data set, it calculates the average similarity between the unclassified electricity consumption data set and each second-level electricity consumption data group, selecting one electricity consumption pattern label as the classification result for the unclassified electricity consumption data set.

This invention first uses electricity consumption feature information for the initial clustering process and then conducts a second clustering phase through feature extraction. Empirical evidence has shown that it can achieve distinct and varied clustering results. While classifying the unclassified electricity consumption data sets based on this clustering result as the classification model, the resulting electricity consumption pattern classification not only points out the user's electricity consumption amount features, but also further indicates this user's electricity consumption pattern type. In this way, the electricity consumption pattern classification result accurately reflects the user's actual electricity consumption pattern, benefiting the power providers in offering customized electricity adjustment suggestions, or predicting the user's future electricity behavior more accurately, such that the users can adjust their electricity consumption behavior in time. When using these electricity consumption data sets for big data analysis of electricity consumption behaviors or further constructing analytical or predictive models, the accurate electricity consumption pattern classification model offers significant assistance, effectively enhancing the accuracy of analytical results or the performance of predictive models.

Other objectives, advantages and novel features of the invention will become more apparent from the following detailed description when taken in conjunction with the accompanying drawings.

### BRIEF DESCRIPTION OF THE DRAWINGS

FIG. 1 is a system block diagram of the user electricity consumption pattern classification system of the present invention.

FIG. 2 is a flowchart of the user electricity consumption pattern classification method of the present invention.

FIG. 3 is a schematic diagram of the first-level electricity consumption data groups generated by the user electricity consumption pattern classification system of the present invention.

FIG. 4 is a schematic diagram of both the first-level and second-level electricity consumption data groups generated by the user electricity consumption pattern classification system of the present invention.

FIG. 5 is an average curve diagram of the second-level electricity consumption data groups produced by the user electricity consumption pattern classification system of the present invention.

FIG. 6 is another average curve diagram of the second-level electricity consumption data groups produced by the user electricity consumption pattern classification system of the present invention.

### DETAILED DESCRIPTION OF THE INVENTION

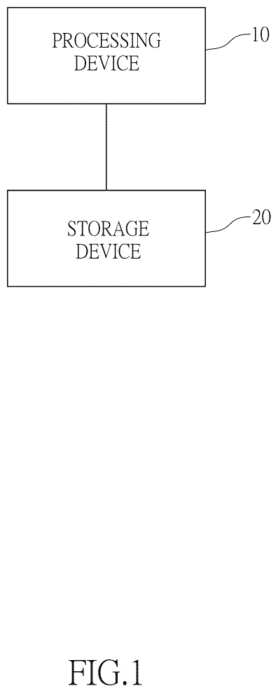

With reference to FIG. 1, a user electricity consumption pattern classification system of the present invention mainly includes a processing device 10 and a storage device 20. The storage device 20 stores multiple training electricity consumption data sets (hereinafter referred to as “training data sets”). Each training data sets includes multiple unit-time electricity consumption values (hereinafter referred to as “unit-time values”) with temporal dependence, and each training data sets, respectively, has a consumption amount feature information. The processing device 10 is connected to the storage device 20 to read the training data sets.

Preferably, the time cycle of the training data sets is the same. For example, the time cycle of each training data set is 1 day. The unit-time value in the training data sets is the electricity consumption load of the user within a unit-time period. The unit-time period may be, for example, 15, 30, or 60 minutes, and the unit of the unit-time value may be Watt. For example, if the time cycle of the training data sets is 1 day, and the sampling unit-time period is 30 minutes, then there are 48 unit-time values in one training data set.

In an embodiment, when the processing device 10 receives multiple raw electricity consumption data sets (hereinafter referred to as “raw data sets”) from a data source device, the processing device 10 may perform at least one of, or a combination of, a data integration procedure, a data cleaning procedure, a data resampling procedure, and a data normalization procedure on the raw data sets to generate the training electricity consumption data sets, and stores the training electricity consumption data sets in the storage device 20. The data normalization procedure may be a Max-min normalization procedure.

In an embodiment, the consumption amount feature information includes a total consumption amount value and a maximum consumption amount value. The total consumption amount value may be, for example, the sum of the unit-time values in a training data set. The maximum consumption amount value may be, for example, the highest of the unit-time values in a training data set, and the total consumption amount value and the maximum consumption amount value of each training data set may be obtained from pre-calculation and stored in the storage device in advance. Or they may be generated by the processing device 10 when the processing device reads the training data sets. The invention is not limited to such.

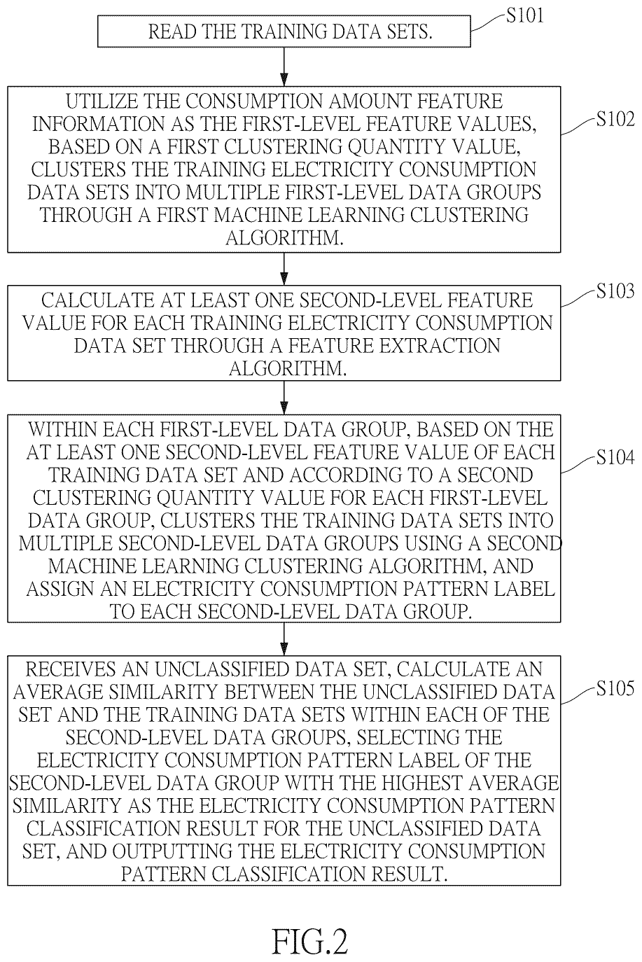

With reference to FIG. 2, the electricity consumption pattern classification method of the present invention, performed by the processing device 10, includes steps S101-S105. The steps will be further explained in detail herein.

In step S101, the processing device 10 reads the training data sets from the storage device 20.

In step S102, the processing device 10 utilizes the consumption amount feature information as the first-level feature values, and based on a first clustering quantity value, clusters the training electricity consumption data sets into multiple first-level electricity consumption data groups (hereinafter referred to as “first-level data groups”) through a first machine learning clustering algorithm.

In this embodiment, the electricity consumption feature information includes two values: the total consumption amount value and the maximum consumption amount value. In other words, the aforementioned first machine learning clustering algorithm employs two feature values for clustering. In this embodiment, the first clustering phase, which utilizes two feature values, produces the first-level data groups that effectively reflect the electricity consumption amount of the training data sets. This step can also be considered a labeling process for the training data sets, serving as a clustering criterion for the subsequent second clustering phase, making the overall invention resemble a semi-supervised electricity clustering technique for electricity consumption pattern.

In other embodiments, the consumption feature information may also include values that represent the “consumption amount” feature of the training data sets. For example, an average value, a root mean square value, a median value of the unit-time values of a training data set.

In one embodiment, the first clustering quantity value is 2. The first clustering quantity value can be, for example, received through a user interface of the processing device 10 as a user input value, or based on user's preset values stored in the storage module. As a result, two first-level data groups will be produced through the first machine learning clustering algorithm.

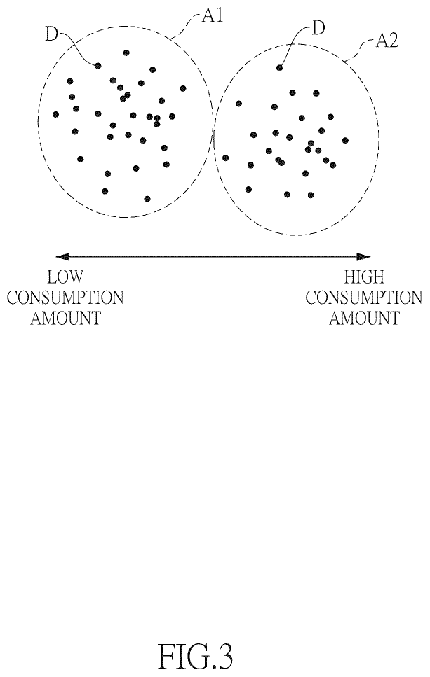

Please also refer to FIG. 3, where each training data set is represented by a data point D. Since the clustering in step S102 uses consumption amount information as feature, the two generated first-level data groups can be considered as representing a “Low Consumption Amount Group A1” and a “High Consumption Amount Group A2”. In other embodiments, when the first clustering quantity value is 3, three first-level data groups will be produced, which can be regarded as representing a “First-level Consumption Amount Group”, a “Second-level Consumption Amount Group”, and a “Third-level Consumption Amount Group”, respectively, and so on by analogy.

Preferably, the first machine learning clustering algorithm is either one of the K-means clustering algorithm and the Hierarchical Clustering algorithm.

In step S103, the processing device 10 calculates, at least one second-level feature value for each training electricity consumption data set through a feature extraction algorithm.

In one embodiment, the number of the at least one second-level feature value is 2. In other words, the feature extraction algorithm produces 2 second-level feature values with the unit-time values of each training data set. In one embodiment, the feature extraction algorithm is, for example, a Principal Components Analysis (PCA) algorithm. The PCA algorithm is primarily used for extracting features from high-dimensional data, generating lower-dimensional feature values to enhance the efficiency of subsequent computations.

Unlike the method in step S101, which uses consumption amount information as a first-level feature value, the second-level feature values are generated by the feature extraction algorithm to produce a more objective clustering result in the second clustering phase.

In step S104, the processing device 10, within each first-level data group, based on the at least one second-level feature value of each training data set and according to a second clustering quantity value for each first-level data group, clusters the training data sets into multiple second-level electricity consumption data groups (hereinafter referred to as “second-level data groups”) using a second machine learning clustering algorithm. Each of these second-level data groups is then assigned an electricity consumption pattern label.

In one embodiment, the second clustering quantity value for each first-level data group is generated through a clustering quantity determination algorithm. More specifically, the processing device 10 processes the second-level feature values of the electricity consumption data sets within these first-level data groups through the clustering quantity determination algorithm to produce the second clustering quantity value for each first-level data group. Taking the two first-level data groups as an example, the processing device 10 first performs the clustering quantity determination algorithm based on the second-level feature values of the training data sets in the Low Consumption Amount Group A1, generating a second clustering quantity value specific to the Low Consumption Amount Group A1. It then performs the clustering quantity determination algorithm based on the second-level feature values of the training data sets in the High Consumption Amount Group A2, generating a second clustering quantity value specific to the High Consumption Amount Group A2. In other words, in the second clustering phase, different first-level data groups may have different numbers of second-level data groups.

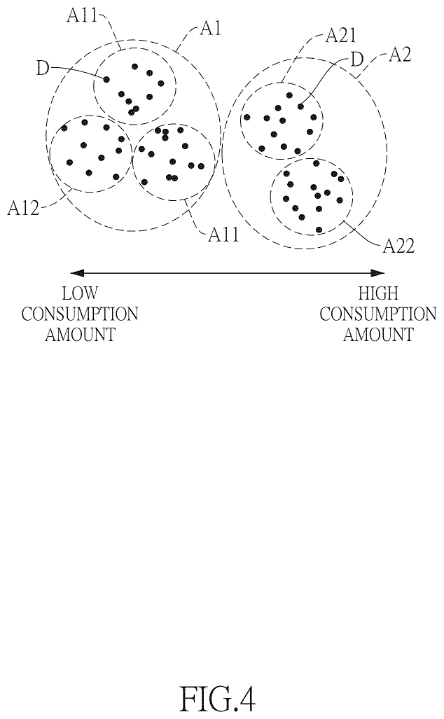

With reference to FIG. 4, in this hypothetical example, through the clustering quantity determination algorithm, the second clustering quantity value for the Low Consumption Amount Group A1 is 3, and the second clustering quantity value for the High Consumption Amount Group A2 is 2. Thus, three second-level data groups A11-A13 are generated within the Low Consumption Amount Group A1, and two second-level data groups A21 and A22 are generated within the High Consumption Amount Group A2.

This step further produces more refined second-level data groups as the clustering results within the first-level data groups. These second-level data groups constitute the electricity consumption pattern classification model of the present invention, which can be used to classify the received unclassified electricity consumption data sets.

Specifically, the clustering quantity determination algorithm is the Elbow Method. The second machine learning clustering algorithm is an unsupervised clustering algorithm, such as either the k-means clustering algorithm or the Hierarchical Clustering algorithms.

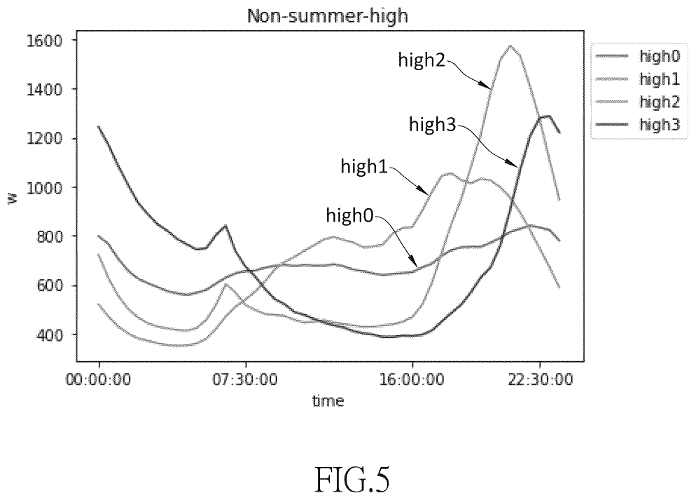

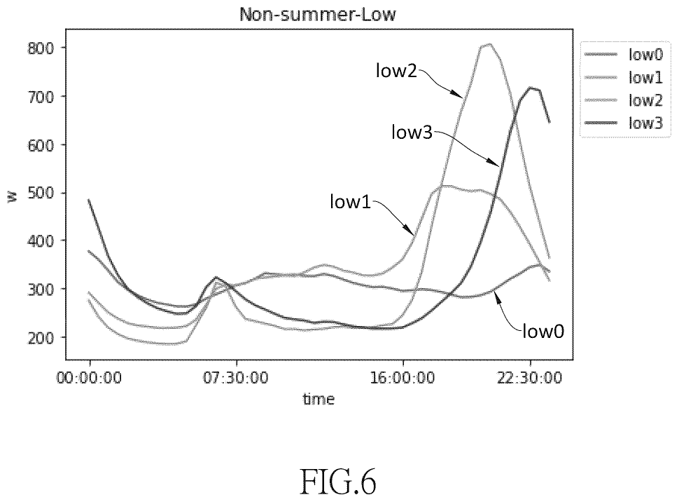

To verify the effectiveness of the second-level data groups produced by the user electricity consumption pattern classification system and method of this invention, FIGS. 5 and 6 show the result charts of the average curves of the second-level data groups generated based on a set of real electricity consumption data sets as input using the method of this invention. In this example, both of the two first-level data groups have a second clustering quantity value of 4, determined by the clustering quantity determination algorithm. Therefore, both first-level data groups each produce four second-level data groups. Specifically, FIG. 5 shows the average curves high0˜high3 for the four second-level data groups under the first-level data group “high consumption amount group A2”, and FIG. 6 shows the average curves low0˜low3 for the four second-level data groups under the first-level data group “low consumption amount group A1”.

It should be noted that, in the charts of FIGS. 5 and 6, the vertical axis values have different scales and magnitudes. In the “high consumption amount group A2” of FIG. 5, the highest value is approximately 1600 W, and the vertical axis (load) spacing is 200 W. In the “low consumption amount group A1” of FIG. 6, the highest value is about 800 W, and the vertical axis spacing is 100 W. In other words, the first clustering phase of the invention effectively clusters all the training data sets into two first-level consumption data groups based on consumption amount information.

Furthermore, among the totally 8 curves of the curves high0˜high3 in FIG. 5 and curves low0˜low3 in FIG. 6, each curve possesses distinct shape and trend characteristics. This shows that, in the second clustering phase of this invention, the second-level consumption data groups not only have different value ranges but also distinct trend characteristics, successfully representing different electricity consumption patterns. The outcome proves the second-level consumption data groups produced by this invention effectively reflect different electricity consumption situations.

In step S105, the processing device 10 receives an unclassified electricity consumption data set (hereinafter referred to as the unclassified data set), the processing device 10 calculates an average similarity between the unclassified data set and the training data sets within each of the second-level data groups, selecting the electricity consumption pattern label of the second-level data group with the highest average similarity as the electricity consumption pattern classification result for the unclassified electricity consumption data set, and outputting the electricity consumption pattern classification result.

In other words, when the processing device 10 receives a new unclassified data set, it classifies the unclassified data set to any of the second-level data groups based on similarity calculation.

In an embodiment, when the processing device 10 calculates the average similarity between the unclassified data set and each of the second-level data groups, it first calculates the average curve of the training data sets within each second-level data group. Then, it calculates the data distance between the unclassified data set and the average curve of each second-level data group. Finally, the average similarity is produced based on the reciprocal of the data distance between the unclassified data set and the average curve of each second-level consumption data group.

Preferably, the data distance may be the Euclidean Distance. Alternatively, the data distance may also be obtained by any data distance algorithm in machine learning technology field for calculating data similarity.

The higher the average similarity, the more similar the trend of the unclassified data sets and the second-level data group. Therefore, the electricity consumption pattern label of the second-level data group with the highest average similarity to the unclassified data set is chosen as the electricity consumption pattern classification result.

In summary, the user electricity consumption pattern classification system and method of the present invention provide a comprehensive method for generating an electricity consumption pattern classification model, as well as a complete technical solution for producing electricity consumption pattern classification results based on the consumption pattern classification model. The electricity consumption pattern classification model produced by the present invention first considers the consumption amount feature of the training data sets for the first clustering phase, followed by the second clustering phase based on feature values generated by the feature extraction algorithm. Empirical evidence suggests that the second-level data groups produced in this manner, under preliminary grouping based on consumption amount features, more precisely reflects different user consumption patterns compared to classifications based solely on different time period electricity proportions. This allows power companies to provide more accurate customized electricity adjustment recommendations.

Furthermore, since both the training data sets and the unclassified data sets to be analyzed have the same time period (e.g., one day) as their time cycle, the electricity consumption data sets from the same user in every time cycle can be classified using this invention, producing electricity consumption pattern classification results for every time cycle. After collecting and analyzing data over multiple time cycles of a user, one can predict a user's electricity consumption patterns on different dates/time cycles, establishing user electricity consumption habit data over multiple time cycles. In this way, power companies can provide real-time reminders to users when they deviate from their original electricity consumption habits, enabling users to promptly adjust their electricity consumption behavior or check for abnormality.

Additionally, the more precise electricity consumption pattern classification model of this invention and resulting classifications are also suitable to be applied to the Non-Intrusive Load Monitoring (NILM) technology, which is actively developed in recent years in many countries. While serving as training feature data source for NILM, the present invention also enhances the performance of monitoring, anomaly detection, electricity consumption prediction models, and other technologies based on NILM.

Lastly, the electricity consumption pattern classification model produced by this invention can be used to analyze large amounts of electricity data from a large number of electricity users, assisting power companies in formulating different electricity rate plans, such as electricity rate plans suitable for specific household demographics and schedules.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A user electricity consumption pattern classification system, comprising:
a storage device, storing multiple training electricity consumption data sets, each of the training electricity consumption data sets including multiple unit-time electricity consumption values with temporal dependence, and each of the training electricity consumption data sets having a consumption amount feature information; and
a processing device, connected to the storage device, the processing device being configured to read the training electricity consumption data sets from the storage device;
the processing device utilizing the consumption amount feature information of the training electricity consumption data sets as a first-level feature value and, based on a first clustering quantity value, clustering the training electricity consumption data sets into multiple first-level electricity consumption data groups through a first machine learning clustering algorithm;
the processing device calculating, through a feature extraction algorithm, at least one second-level feature value for each training electricity consumption data set;
within in each of the first-level electricity consumption data groups, the processing device, based on the at least one second-level feature value of each of the training electricity consumption data sets, and based on a second clustering quantity value of each of the first-level electricity consumption data groups, clustering the training electricity consumption data sets into multiple second-level electricity consumption data groups through a second machine learning clustering algorithm, and assigning an electricity consumption pattern label to each of the second-level electricity consumption data groups;
the processing device receiving an unclassified electricity consumption data set, calculating an average similarity between the unclassified electricity consumption data set and the training electricity consumption data sets within each of the second-level electricity consumption data groups, selecting the electricity consumption pattern label of the second-level electricity consumption data group with the highest average similarity as a classification result for the unclassified electricity consumption data set, and outputting an electricity consumption pattern classification result.

2. The user electricity consumption pattern classification system as claimed in claim 1, wherein within each of the first-level electricity consumption data groups, the processing device generates the second clustering quantity value through a clustering quantity determination algorithm based on the at least one second-level feature value of each training electricity consumption data set.

3. The user electricity consumption pattern classification system as claimed in claim 1, wherein when the processing device calculates the average similarity between the unclassified electricity consumption data set and the training electricity consumption data sets within each of the second-level electricity consumption data groups, the processing device first calculates an average curve for the training electricity consumption data sets within each of the second-level electricity consumption data groups, then calculates a data distance between the unclassified electricity consumption data set and the average curve of each second-level electricity consumption data group, and finally generates the average similarity based on the reciprocal of the data distance between the unclassified electricity consumption data set and each of the second-level electricity consumption data groups.

4. The user electricity consumption pattern classification system as claimed in claim 1, wherein the processing device receives multiple raw electricity consumption data sets from a data source device and performs at least one of, or a combination of, a data integration procedure, a data cleaning procedure, a data resampling procedure, and a data normalization procedure on the raw electricity consumption data sets to generate the training electricity consumption data sets, and stores the training electricity consumption data sets in the storage device.

5. The user electricity consumption pattern classification system as claimed in claim 2, wherein the clustering quantity determination algorithm is Elbow Method.

6. The user electricity consumption pattern classification system as claimed in claim 1, wherein the first machine learning clustering algorithm is one of K-means clustering algorithm and Hierarchical Clustering algorithm.

7. The user electricity consumption pattern classification system as claimed in claim 1, wherein the feature extraction algorithm is Principal Components Analysis algorithm.

8. The user electricity consumption pattern classification system as claimed in claim 1, wherein the consumption amount feature information includes a total consumption amount value and a maximum consumption amount value.

9. The user electricity consumption pattern classification system as claimed in claim 1, wherein the first clustering quantity value is 2, and the number of the at least one second-level feature value is 2.

10. A user electricity consumption pattern classification method, executed by a processing device of a user electricity consumption pattern classification system, the method comprising the following steps of:
reading multiple training electricity consumption data sets, each of the training electricity consumption data set including multiple unit-time electricity consumption values with temporal dependence, and each of the training electricity consumption data sets having a consumption amount feature information;
utilizing the consumption amount feature information of the training electricity consumption data sets as a first-level feature value and, based on a first clustering quantity value, clustering the training electricity consumption data sets into multiple first-level electricity consumption data groups through a first machine learning clustering algorithm;
calculating, through a feature extraction algorithm, at least one second-level feature value for each training electricity consumption data set;
within each of the first-level electricity consumption data groups, based on the at least one second-level feature value of each of the training electricity consumption data sets, and based on a second clustering quantity value of each of the first-level electricity consumption data groups, clustering the training electricity consumption data sets into multiple second-level electricity consumption data groups through a second machine learning clustering algorithm, and assigning an electricity consumption pattern label to each of the second-level electricity consumption data groups; and
receiving an unclassified electricity consumption data set, calculating an average similarity between the unclassified electricity consumption data set and the training electricity consumption data sets within each of the second-level electricity consumption data groups, selecting the electricity consumption pattern label of the second-level electricity consumption data group with the highest average similarity as an electricity consumption pattern classification result for the unclassified electricity consumption data set, and outputting the electricity consumption pattern classification result.

11. The user electricity consumption pattern classification method as claimed in claim 10, further comprising the following steps:
within each of the first-level electricity consumption data groups, generating the second clustering quantity value through a clustering quantity determination algorithm based on the at least one second-level feature value of each training electricity consumption data set.

12. The user electricity consumption pattern classification method as claimed in claim 10, wherein the step “the processing device calculates the average similarity between the unclassified electricity consumption data set and the training electricity consumption data sets within each of the second-level electricity consumption data groups” further comprises:
calculating an average curve for the training electricity consumption data sets within each of the second-level electricity consumption data groups, and calculating a data distance between the unclassified electricity consumption data set and the average curve of each second-level electricity consumption data group, and finally generating the average similarity based on the reciprocal of the data distance between the unclassified electricity consumption data set and each of the second-level electricity consumption data groups.

13. The user electricity consumption pattern classification method as claimed in claim 10, further comprising the following steps:
receiving multiple raw electricity consumption data sets from a data source device, and performing at least one of, or a combination of, a data integration procedure, a data cleaning procedure, a data resampling procedure, and a data normalization procedure on the raw electricity consumption data sets to generate the training electricity consumption data sets, and storing the training electricity consumption data sets to the storage device.

14. The user electricity consumption pattern classification method as claimed in claim 11, wherein the clustering quantity determination algorithm is Elbow Method.

15. The user electricity consumption pattern classification method as claimed in claim 10, wherein the first machine learning clustering algorithm is one of K-means clustering algorithm and Hierarchical Clustering algorithm.

16. The user electricity consumption pattern classification method as claimed in claim 10, wherein the feature extraction algorithm is Principal Components Analysis algorithm.

17. The user electricity consumption pattern classification method as claimed in claim 10, wherein the consumption amount feature information includes a total consumption amount value and a maximum consumption amount value.

18. The user electricity consumption pattern classification method as claimed in claim 10, wherein the first clustering quantity value is 2, and the number of the at least one second-level feature value is 2.
